(19) United States
(12) Patent Application Publication
(10) Pub. No.: US 2021/0171726 A1
(43) Pub. Date: Jun. 10, 2021

(54) MOLDED ARTICLE AND PRODUCTION METHOD THEREFOR

(71) Applicant: Kureha Corporation, Tokyo (JP)

(72) Inventors: Tatsuaki MIYASHITA, Tokyo (JP); Kazuyuki SUZUKI, Tokyo (JP)

(73) Assignee: Kureha Corporation, Tokyo (JP)

(21) Appl. No.: 16/769,315

(22) PCT Filed: Aug. 29, 2018
(86) PCT No.: PCT/JP2018/031924

§ 371 Date: Jun. 3, 2020

(30) Foreign Application Priority Data
Dec. 8, 2017 (JP) 2017-236519

(51) Int. Cl. C08J 5/18; B29C 71/02

(52) U.S. Cl. CPC C08J 5/18; B29C 71/02; B29K 2027/16; B29C 2071/022; C08J 2327/16

(57) ABSTRACT

There are provided a molded article of a composition containing a vinylidene fluoride-based polymer which, although having a thickness of greater than 50 μm, has a low haze, and a novel method for producing the molded article. The molded article of vinylidene fluoride-based polymer of the present invention has a thickness greater than 50 μm and a haze of 40% or less. In the production of a molded article, a composition of a vinylidene fluoride-based polymer having a predetermined shape is melted at a temperature within a range of the melting point of the polymer ±5° C. and molded.

### TECHNICAL FIELD

The present invention relates to a molded article made of a vinylidene fluoride-based polymer and a method for producing the same.

### BACKGROUND ART

Film- or sheet-shaped molded articles of polyvinylidene fluoride (PVDF) (hereafter, also referred to as “sheet molded articles”) may appear cloudy white. This is because when the size of the spherulites generated during molding is larger than the wavelengths of the visible light, the light is scattered in the sheet molded article. For this reason, in general, the haze of a PVDF sheet molded article having such spherulites is high, and thus, such a sheet molded article is opaque.

As a technique for lowering the haze of PVDF sheet molded articles having a thickness of 50 μm or less, there is known a technique for stretch-orientation of PVDF in a sheet molded article upon cooling of the sheet molded article after melt extrusion (e.g., see Patent Document 1).

Additionally, as a technique for lowering the haze of sheet molded articles, there is known a technique in which a PVDF copolymer, which is a polymer having a lower crystallinity, is used as a material polymer and rapidly cooled during molding (e.g., see Patent Document 2). This technique controls the number and growth of spherulites in the sheet molded article to lower the haze of the sheet molded article.

Furthermore, as a technique for lowering the haze of sheet molded articles, there is known a technique in which the degree of crystallinity and haze of the sheet molded article are lowered by using specific monomers as monomers other than vinylidene fluoride in a PVDF copolymer (e.g., see Patent Document 3).

### CITATION LIST

### Patent Document

Patent Document 1: JP 6-080794 A (published on Mar. 22, 1994)
Patent Document 2: JP 6-091735 A (published on Apr. 5, 1994)
Patent Document 3: WO 2010/005755 (published on Jan. 14, 2010)

### SUMMARY OF INVENTION

### Technical Problem

On the other hand, for a sheet molded article that has a thickness of greater than 50 μm and is formed of a vinylidene fluoride-based polymer, even if the molded article is rapidly cooled, it usually takes time until the inside of the molded article is cooled. As a result, spherulites grow large within the sheet molded article, the haze of the sheet molded article increases, and the sheet molded article may become opaque.

The present invention has been made in view of the foregoing problem, and it is an object of the present invention to provide a molded article of a composition containing a vinylidene fluoride-based polymer, the molded article, even if having a thickness of greater than 50 μm, having a low haze, and a novel method for producing the molded article.

### Solution to Problem

In order to solve the problem described above, a molded article according to one aspect of the present invention is a molded article of a polymer composition that contains a polymer containing vinylidene fluoride as the main component, wherein the polymer composition contains 90 mass % or greater of the polymer containing vinylidene fluoride as the main component, and the molded article has a thickness greater than 50 μm and a haze of 40% or less.

Additionally, in order to solve the problem described above, a method for producing the molded article according to one aspect of the present invention includes a molding step of melting and molding the polymer composition having a shape to be molded. In the above molding step, the polymer composition is melted by heating the polymer composition described above to a temperature in the range of the melting point of the polymer described above ±5° C.

### Advantageous Effects of Invention

According to the above aspect of the present invention, it is possible to provide a molded article of a composition containing a vinylidene fluoride-based polymer, which, although having a thickness of greater than 50 μm, has a low haze, and to provide a novel method for producing the molded article.

### BRIEF DESCRIPTION OF THE DRAWINGS

FIG. 1 is a diagram illustrating the correlation between the thickness and the haze of the molded articles in the Examples and Comparative Examples of the present invention.

### DESCRIPTION OF EMBODIMENTS

Hereinafter, an embodiment of the present invention will be described.

### Molded Article

The molded article according to the embodiment of the present invention is a molded article of a polymer composition that contains a polymer containing vinylidene fluoride as the main component. Hereinafter, this polymer is also referred to as the “vinylidene fluoride-based polymer”. The polymer composition described above is also referred to as the “PVDF-based composition”.

The phrase “containing vinylidene fluoride as the main component” mentions that the vinylidene fluoride-based polymer contains 50 mass % or greater of constituent units derived from vinylidene fluoride. The vinylidene fluoride-based polymer may be a homopolymer of vinylidene fluoride containing substantially 100 mass % of constituent units derived from vinylidene fluoride, or may be a copolymer of vinylidene fluoride further including constituent units derived from other monomers.

One type of other monomers may be used, or two or more types may be used. Other monomers may or may not contain fluorine. Examples of other monomers include tetrafluoroethylene, trifluoroethylene, chlorotrifluoroethylene, hexafluoropropene, vinyl fluoride, 2,3,3,3-tetrafluoropropene, pentafluoropropene, perfluoromethyl vinyl ether, perfluoropropyl vinyl ether, and (meth)acrylic acid esters such as methyl (meth)acrylate and butyl (meth)acrylate.

The PVDF-based composition is a composition containing 90 mass % or greater of the vinylidene fluoride-based polymer described above. The above vinylidene fluoride-based polymers may be one type or a mixture of two or more types. The content of the vinylidene fluoride-based polymer in the PVDF-based composition is 90 mass % or greater, preferably 93 mass % or greater, and even more preferably 98 mass % or greater because a low content results in a decreased crystallinity of the molded article.

The PVDF-based composition may further contain other components as long as effects of the present embodiment can be provided. One type of the other components may be used, or two or more types may be used. Examples of other components described above include additives and other polymers than vinylidene fluoride-based polymers.

From the perspective of suppressing an increase in haze associated with an increase in the thickness of the molded article, the vinylidene fluoride-based polymer is preferably a homopolymer of vinylidene fluoride.

The molecular weight of the vinylidene fluoride-based polymer can be appropriately determined in accordance with the intended physical properties of the molded article. The molecular weight of the vinylidene fluoride-based polymer can be represented by an inherent viscosity, and can be appropriately determined in a range from 0.8 to 2.0 dL/g, for example. The inherent viscosity of the vinylidene fluoride-based polymer is preferably from 0.8 to 2.0 dL/g, from the perspective of moldability, for example. The inherent viscosity can be determined based on a known measurement method, for example, the method defined in JIS K7367-1.

The molded article of the present embodiment has a thickness of greater than 50 μm. The phrase “the thickness of the molded article is greater than 50 μm” means that the thickness at the thinnest portion of the molded article is greater than 50 μm. The shape of the molded article can be appropriately determined as long as the molding mentioned below is feasible. The thickness of the molded article may be the average value of the thicknesses at an appropriate number of points in the thinnest portion of the molded article.

The shape of the molded article in the present embodiment is preferably a shape in which excellent optical properties due to a low haze are effectively expressed, and is preferably a sheet-like shape, for example.

The molded article of the present embodiment has a haze of 40% or less. The phrase “the molded article has a haze of 40% or less” means that the haze value is at most 40% when the thickness of the molded article is 2 mm. The haze of the molded article can be measured by a known method such as a commercially available haze meter, for example. The haze of the molded article may be, for example, a measured haze value measured at any portion of the molded article, or may be a calculated value which is calculated as the haze of a portion having a thickness of 2 mm from the measured haze value of a portion having a thickness greater than 2 mm or less than 2 mm.

The haze of the molded article can be adjusted with, for example, the degree of crystallinity of the vinylidene fluoride-based polymer. In addition, the haze of the molded article can be lowered, for example, by using a vinylidene fluoride homopolymer as the vinylidene fluoride-based polymer.

The thickness of the molded article in the present embodiment can also be determined from the perspective of the haze of the molded article. For example, the thickness of the molded article is preferably 2000 μm or less from the perspective of achieving a haze of 40% or less, preferably 1500 μm or less from the perspective of achieving a haze of 30% or less, and preferably 500 μm or less from the perspective of achieving a haze of 20% or less.

The molded article of the present embodiment tends to have a lower haze as the thickness thereof is smaller. Thus, the thickness of the molded article is preferably smaller from the perspective of sufficiently reducing the haze, but it is possible to appropriately determine the thickness in accordance with other properties such as mechanical strength required for intended uses. For example, from the perspective of further providing sufficient mechanical strength, the thickness of the molded article is preferably 100 μm or greater, preferably 300 μm or greater, or preferably 500 μm or greater.

The molded article of the present embodiment may have additional properties as long as effects of the present embodiment are exerted. For example, a molded article having a crystal melting enthalpy of 40 to 80 J/g as measured by a differential scanning calorimeter (DSC) is preferable, from the perspective of not only achieving the aforementioned low haze but also enhancing other properties such as mechanical strength.

If the crystal melting enthalpy of the molded article is excessively low, the degree of crystallinity of the vinylidene fluoride-based polymer will be insufficient, and the densification of the vinylidene fluoride-based polymer may be lower. As a result, properties such as mechanical strength and gas barrier properties of the molded article may be insufficient. In addition, in the present embodiment, in a case where the crystal melting enthalpy of the molded article is excessively low, transparency may also be insufficient. If the crystal melting enthalpy of the molded article is excessively high, the densification of the molded article may increase. Thus, the molded articles may become brittle, and may be unsuitable from the perspective of the uses of the molded article.

From the perspective of achieving both haze and other properties of the molded article, the crystal melting enthalpy of the molded article is preferably 40 J/g or greater, more preferably 50 J/g or greater, and even more preferably 55 J/g or greater. Additionally, from the perspective of exhibiting properties suitable for the aforementioned intended uses, the crystal melting enthalpy of the molded article is preferably 80 J/g or less, more preferably 75 J/g or less, and even more preferably 70 J/g or less.

The crystal melting enthalpy of the molded article can be determined by a known method by means of DSC. The crystal melting enthalpy of the molded article can also be adjusted by the degree of crystallinity of the vinylidene fluoride-based polymer. For example, the crystal melting enthalpy of the molded article can be increased by using a vinylidene fluoride homopolymer as the vinylidene fluoride-based polymer or by performing an annealing treatment.

Furthermore, for example, the molded article of the present embodiment preferably has a tensile yield stress of 40 MPa or greater, from the perspective of enhancing the mechanical strength thereof. If the tensile yield stress of the molded article is excessively low, it may be unsuitable from the perspective of the uses of the molded article. For example, the tensile yield stress of the molded article is more preferably 55 MPa or greater and even more preferably 60 MPa or greater, from the perspective of the uses of the molded article.

The tensile yield stress of the molded article can be determined by a known method for determining the tensile yield stress of resin molded articles by using samples prepared appropriately as required. The tensile yield stress of the molded article also can be adjusted by the degree of crystallinity of the vinylidene fluoride-based polymer. For example, the tensile yield stress of the molded article can be enhanced by using a vinylidene fluoride homopolymer as the vinylidene fluoride-based polymer or by performing an annealing treatment. On the other hand, when the degree of crystallinity of the molded article is high to a certain degree, the molded article becomes hard, and the tensile yield stress thereof usually reaches a plateau. From this perspective, the tensile yield stress of the molded article may be 80 MPa or less.

Additionally, for example, the molded article of the present embodiment preferably has a haze of 40% or less after subjected to an annealing treatment. This annealing treatment is a heat treatment for removing a distortion occurring during molding of the molded article, as usually performed in the production of molded articles made of resin. The conditions of the annealing treatment can be appropriately determined as long as the treatment is an effective heat treatment on the molded article for the purpose described above.

More specifically, the “annealing treatment” in the “haze after the annealing treatment” described above refers to a treatment in which the molded article at ambient temperature is left for 1 to 2 hours in an environment at a temperature lower than the melting point of the vinylidene fluoride-based polymer (e.g., at 150° C. for 1 hour), and then left to cool to ambient temperature again.

The vinylidene fluoride-based polymer of the molded article in the present embodiment is substantially free of spherulites of a size that can be observed by a light scattering method. The light scattering method is a method of detecting the intensity distribution of scattered light when a laser having a wavelength of 633 nm is vertically applied to the surface of a sheet-like sample, for example. The phrase “substantially free” means that spherulites of the size that can be observed by the light scattering described above may be included within a range where the haze of the molded article is not affected.

The vinylidene fluoride-based polymer of the molded article in the present embodiment has not been subjected to a stretching treatment. That is, the vinylidene fluoride-based polymer of the molded article does not have anisotropy due to a usual stretching treatment on polymer. Thus, pressing in the molding step of the vinylidene fluoride-based polymer mentioned below is not included in the stretching treatment described herein. The molded article of the present embodiment has the aforementioned low haze even if not subjected to the stretching treatment. The presence or absence of the trace by the stretching treatment in the vinylidene fluoride-based polymer can be confirmed by a known method such as X-ray diffraction, infrared spectroscopy, or Raman spectroscopy.

The molded article of the present embodiment may further include other components as long as effects of the present embodiment can be provided. Examples of such other components include additives that are added to the vinylidene fluoride-based polymer. One type of the additives may be used, or two or more types may be used. The content of the additives in the molded article can be appropriately determined as long as both the effects of the present embodiment and the effects of the additives are provided. Examples of additives include a thermal stabilizer, a lubricant, a plasticizer, a bluing agent, an anti-coloration agent, and a crystal nucleating agent.

The molded article of the present embodiment may contain a crystal nucleating agent as an additive, but may not contain a crystal nucleating agent.

### Method for Producing Molded Article

The molded article of the present embodiment can be manufactured by the following production method. The production method includes a molding step of melting and molding a PVDF-based composition having a shape to be molded. In the molding step, the PVDF-based composition may be accommodated in a container such as a mold and held in the shape to be molded as described above, or may be an integral article having the shape to be molded as described above.

The molding step in the present embodiment can be achieved by a known technique capable of melting and molding a solid resin material having a shape to be molded. The molding step can be achieved, for example, by a known powder compression.

The form of the PVDF-based composition to be subjected to the molding step is only required to be applicable to the molding step. Such a form may be, for example, a powder, but may be a pellet, a compact molded product of a powder, or may be a molded product to be accommodated in a mold.

In the molding step in the present embodiment, the PVDF-based composition is melted by heating the composition to a temperature in the range of the melting point of the vinylidene fluoride-based polymer ±5° C. The melting point is the temperature at which the vinylidene fluoride-based polymer in solid phase changes into a liquid phase. This melting point may be the melting point of the PVDF-based composition when the PVDF-based composition is substantially composed of the vinylidene fluoride-based polymer. For example, when the melting point of the PVDF-based composition has a difference of only within ±1° C. than the melting point of the vinylidene fluoride-based polymer included therein, the melting point of the PVDF-based composition may be approximated to the melting point of the vinylidene fluoride-based polymer. The melting point can be determined, for example, from the temperature of the endothermic peak in DSC. More specifically, the melting point can be determined from the peak top temperature at the crystal melting peak observed when the temperature is raised from 30° C. to 230° C. at 10° C./min in DSC.

When the heating temperature in the molding step of the present embodiment is lower than the melting point of the vinylidene fluoride-based polymer by 5° C., the PVDF-based composition may be melted insufficiently, and the haze of the molded article may exceed 40%. When the heating temperature in the molding step is higher than the melting point by 5° C., spherulites of usual size may be formed in the PVDF-based composition, and the haze of the molded article may exceed 40% as well.

The time of the heating temperature (heating time) in the molding step can be appropriately determined within the range where an adequate melt state of the vinylidene fluoride-based polymer in the molten PVDF-based composition is achieved. This heating time can be appropriately determined in a range from 1 to 30 minutes, for example.

In addition, the pressure at the heating temperature in the molding step can be appropriately determined within a range in which the mold is sufficiently densely filled with the molten PVDF-based composition. For example, the pressure in the molding step may be normal pressure provided that the mold can be sufficiently densely filled with the molten PVDF-based composition. In the case where a powder is used for the resin material in the molding step, the powder is preferably pressurized from the perspective of densely filling the mold with the PVDF-based composition. The pressure at the heating temperature in this case can be appropriately determined from a range from 5 to 20 MPa.

The mold used in the molding step is only required to be a member that can be used for heating and pressurization in the molding step and can hold the molten PVDF-based composition in a shape to be molded. Examples of such molds include metal molds and metal sheets such as aluminum foil.

In the case where the shape of the molded article in the present embodiment is a sheet-like shape, from the perspective of achieving a uniform thickness and a smooth surface of the molded article, in addition to the aforementioned perspective of sufficiently dense filling, the PVDF-based composition is preferably pressurized during heating in the molding step. That is, preferably, in the molding step, the composition is pressed by a press member and formed into a sheet-like shape while the PVDF-based composition is melted by heating the press member. The press member is only required to be a known member capable of implementing the aforementioned heating and pressurization.

From the perspective of increasing the degree of crystallinity of the molded article obtained in the molding step, the vinylidene fluoride-based polymer is preferably a homopolymer of vinylidene fluoride. Furthermore, in a case where the melting point thereof is excessively low, the mechanical strength of the molded article may be insufficient, and in a case where the melting point thereof is excessively high, the molding processability may be insufficient. From such a perspective, the melting point of the vinylidene fluoride homopolymer is preferably from 165 to 180° C. and higher preferably from 170 to 180° C.

The production method of the present embodiment may further include other steps than the aforementioned molding step as long as the effects of the present embodiment can be obtained. Examples of such other steps include a preheating step in which the mold is preheated prior to the aforementioned molding step, a molded product making step in which a molded product of a PVDF-based composition to be subjected to a molding step is made in a mold prior to the molding step, a gradual cooling step of gradually cooling the molded product after the molding step, and an annealing step of annealing the molded article obtained in the molding step.

The preheating step is preferable from the perspective of rapidly and stably achieving the temperature of the PVDF-based composition in the range of the heating temperature in the molding step. In the preheating step, the mold to accommodate the PVDF-based composition is preferably maintained at a temperature equal to or lower than the melting point of the vinylidene fluoride-based polymer, for example, a temperature 20 to 0° C. lower than the melting point, from the perspective of achieving rapid heating of the mold. Preheating in the preheating step may be performed with the same apparatus as the heating apparatus in the molding step or may be performed with a different apparatus.

The molded product making process is preferable from the perspective of facilitating molding of a molded article having a complex shape. The molded product can be made by a known method such as injection molding. The mold for molding the molded product may be the same as or different from the mold in the molding step.

The gradual cooling step is preferable from the perspective of increasing the degree of crystallinity and suppressing changes in the degree of crystallinity during the annealing treatment. The gradual cooling step is only required to be at a rate sufficiently slow to exhibit the effect. For example, the gradual cooling step can be performed by leaving the mold containing a molded product after the molding step in the air (air cooling).

The annealing step is, as mentioned above, a step in which the molded article at ambient temperature (e.g., 23° C.) is left for 1 to 2 hours in an environment at a temperature lower than the melting point of the vinylidene fluoride-based polymer (e.g., at 150° C. for 1 hour), and then left to cool to ambient temperature again. The annealing step is preferable from the perspective of reducing the stress remaining in the molded article. The annealing step can be performed in the same manner as a known annealing treatment for resin molded articles.

The molded article of the present embodiment is a molded article of a PVDF-based composition having a vinylidene fluoride-based polymer as the main component, and has a thickness of greater than 50 μm and a sufficiently low haze of 40% or less. The reason for this can be conceived as follows.

The molded article of the present embodiment is conceived to have a relatively high degree of crystallinity from its crystal melting enthalpy. Meanwhile, when the molded article of the present embodiment is observed by light scattering of a laser (wavelength of 633 nm), the spherulitic structure cannot be confirmed. Thus, it is conceived that the vinylidene fluoride-based polymer in the molded article has a high degree of crystallinity due to the crystalline structures comprising spherulites of a size at least less than the wavelength of the laser, for example, less than 600 nm. Thus, it is conceived that the size of the spherulites in the crystalline structure in the molded article is sufficiently small compared with the wavelength of light, as mentioned above. Thus, it is conceived that the molded article of the present embodiment has a low haze even if having a thickness greater than 50 μm.

In contrast, known sheet molded articles made of PVDF generally have spherulites of a size of the order of microns, for example, of approximately 10 to 20 μm. The known sheet molded articles thus have spherulites sufficiently large with respect to the wavelength of visible light. Therefore, when the thickness of the molded article increases, the haze of the molded article also increases.

In general, in production of a molded article made of a vinylidene fluoride-based polymer, it is conceivable to make smaller spherulites by dispersing a crystal nucleating agent in the vinylidene fluoride-based polymer to grow crystals from a large number of nuclei due to the crystal nucleating agent during cooling after melting. However, an attempt of using a crystal nucleating agent as described above cannot enhance the transparency of the molded article described above as the present embodiment can. The above attempt of using a crystal nucleating agent has a problem in that it is difficult to uniformly disperse the crystal nucleating agent in the molten vinylidene fluoride-based polymer and a problem in that the thermal stability of the crystal nucleating agent is generally insufficient and thus the molten vinylidene fluoride-based polymer is colored by decomposition of the crystal nucleating agent.

### SUMMARY

As is clear from the description above, the molded article according to the present embodiment is a molded article of a polymer composition that contains a polymer containing vinylidene fluoride as the main component (PVDF-based composition), in which the PVDF-based composition contains 90 mass % or greater of the polymer containing vinylidene fluoride as the main component, and the molded article has a thickness greater than 50 μm and a haze of 40% or less. Thus, the molded article of the present embodiment is a molded article made of a vinylidene fluoride-based polymer, and has a low haze even if the molded article made of a vinylidene fluoride-based polymer has a thickness greater than 50 μm.

Furthermore, that the crystal melting enthalpy, as measured by a differential scanning calorimeter, in the molded article of the present embodiment is 40 J/g or greater and 80 J/g or less (40 to 80 J/g) is further effective, from the perspective of enhancing both the low haze and the other properties such as mechanical strength.

Furthermore, that the molded article of the present embodiment has a tensile yield stress of 40 MPa or greater is further effective, from the perspective of producing the molded article for uses requiring a high mechanical strength.

In addition, that the haze after the annealing treatment is 40% or less in the molded article of the present embodiment is further effective, from the perspective of eliminating thermal stress during production of a molded article and producing a molded article having a sufficiently low haze.

Furthermore, that the vinylidene fluoride-based polymer is a vinylidene fluoride homopolymer is further effective, from the perspective of increasing the degree of crystallinity of the molded article of the present embodiment.

Furthermore, that the molded article of the present embodiment is in a sheet-like shape is further effective, from the perspective that excellent optical properties, such as a low haze possessed by the molded article, are effectively expressed.

Furthermore, the method for producing a molded article in the present embodiment includes a molding step of melting and molding a PVDF-based composition having a shape to be molded. Then, in this molding step, the PVDF-based composition is heated to a temperature in the range of the melting point of the vinylidene fluoride-based polymer ±5° C. Thus, according to the production method of the present embodiment, a molded article made of a PVDF-based composition that has a low haze in spite of having a thickness greater than 50 μm can be obtained by a novel production method not previously provided.

Furthermore, in the molding step, that the PVDF-based composition is pressed by a press member and formed into a sheet-like shape while the PVDF-based composition is melted by heating the press member is further effective, from the perspective of achieving a uniform thickness and a smooth surface of the molded article in addition to the perspective of sufficiently densely filling the mold with the PVDF-based composition in the molding step.

Furthermore, that the vinylidene fluoride-based polymer is a vinylidene fluoride homopolymer and the melting point of the vinylidene fluoride-based polymer is 170 to 180° C. is more effective, from the perspective of increasing the degree of crystallinity of the molded article and the perspective of sufficiently expressing both the mechanical strength of the molded article and the molding processability of the PVDF-based composition.

As is clear from the description hereinabove, according to the present embodiment, the PVDF-based composition is molded under heating to a temperature in the range of the melting point of the vinylidene fluoride-based polymer ±5° C. Thereby, according to the present embodiment, it is possible to suppress the growth of spherulites in the molded article and prevent increase in the haze of the molded article. Therefore, even in a molded article having a thickness of greater than 50 μm, it is possible to suppress its haze to 40% or less.

As described above, the molded article in the present embodiment has a large thickness and a low haze, although made of a PVDF-based composition. Therefore, the molded article in the present embodiment can be utilized for highly-transparent members, particularly for members having a preferable combination of characteristics specific to fluorine resins (chemical resistance, weather resistance, gas barrier property, and the like) with transparency.

The present invention is not limited to the embodiments described above, and various modifications are possible within the scope indicated in the claims. Embodiments obtained by appropriately combining the technical means disclosed by other embodiments are also included in the technical scope of the present invention.

### EXAMPLES

Hereinafter, the present invention will be described more specifically by way of examples.

### Preparation of Polymers 1 to 7

The following polymers 1 to 7 were prepared.
Polymer 1: KUREHA KF polymer W #850 (melting point: 175° C., vinylidene fluoride homopolymer, inherent viscosity: 0.85 dl/g)
Polymer 2: KUREHA KF polymer W #1000 (melting point: 175° C., vinylidene fluoride homopolymer, inherent viscosity: 1.0 dl/g)
Polymer 3: KUREHA KF polymer W #1100 (melting point: 175° C., vinylidene fluoride homopolymer, inherent viscosity: 1.1 dl/g) Polymer 4: KUREHA KF polymer W #1300 (melting point: 175° C., vinylidene fluoride homopolymer, inherent viscosity: 1.3 dl/g)
Polymer 5: KUREHA KF polymer W #2100 (melting point: 157° C., vinylidene fluoride copolymer, inherent viscosity: 1.5 dl/g)
Polymer 6: KUREHA KF polymer W #2300 (melting point: 151° C., vinylidene fluoride copolymer, inherent viscosity: 1.0 dl/g)
Polymer 7: KUREHA KF polymer W #1500 (melting point: 168° C., vinylidene fluoride copolymer, inherent viscosity: 1.0 dl/g)

### Example 1

A sufficient amount of the polymer 2 was sandwiched between aluminum foils, further sandwiched between stainless steel (SUS) plates, and pressed at 175° C. for 10 minutes under a pressure of 10 MPa, using a compression molding machine (Model AYSR-5, available from Shinto Metal Industries, Ltd.). Next, the pressed product was allowed to cool in the air for 30 minutes while being sandwiched between the SUS plates (hereinafter, this cooling method is also referred to as the “cooling method 1” (gradual cooling)). A sheet-like molded article 1 was thus produced. The thickness of the molded article 1 was measured five times per sample using a thickness gauge “DG-925” (available from Ono Sokki Co., Ltd.) to determine the average value. This average value is taken as the thickness of the molded article 1. The thickness of the molded article 1 was 2.0 mm.

### Examples 2 to 7

Molded articles 2 to 7 were each prepared in the same manner as in Example 1 except that the distance for sandwiching the polymer in the compression molding machine was changed. The thickness of the molded articles 2 to 7 was 1.7 mm, 1.2 mm, 0.6 mm, 0.2 mm, 1.4 mm, and 1.6 mm, respectively.

### Examples 8 to 10

Molded articles 8 to 10 were prepared in the same manner as in Example 7 except that the polymers 1, 3, and 4 were each used instead of the polymer 2. The thickness of the molded articles 8 to 10 was 1.5 mm, 1.5 mm, and 1.6 mm, respectively.

### Example 11

A molded article 11 was prepared in the same manner as in Example 1 except that the polymer 5 was used instead of the polymer 2, the press temperature was changed from 175° C. to 162° C., and the distance for sandwiching the polymer in the compression molding machine was changed. The thickness of the molded article 11 was 1.5 mm.

### Example 12

A molded article 12 was prepared in the same manner as in Example 1 except that the polymer 6 was used instead of the polymer 2, the press temperature was changed from 175° C. to 156° C., and the distance for sandwiching the polymers was sandwiched in the compression molding machine was changed. The thickness of the molded article 12 was 0.9 mm.

### Example 13

A molded article 13 was prepared in the same manner as in Example 1 except that the polymer 7 was used instead of the polymer 2, the press temperature was changed from 175° C. to 172° C., and the distance for sandwiching the polymer in the compression molding machine was changed. The thickness of the molded article 13 was 1.0 mm.

### Example 14

A molded article 14 was prepared in the same manner as in Example 1 except that the polymer 7 was used instead of polymer 2, the press temperature was changed from 175° C. to 165° C., and the distance for sandwiching the polymer in the compression molding machine was changed. The thickness of the molded article 14 was 1.4 mm.

### Comparative Example 1

A sheet-like molded article C1 was prepared in the same manner as in Example 1 except that the press temperature was changed from 175° C. to 230° C., the distance for sandwiching the polymers in the compression molding machine was changed, the press time was changed from 10 minutes to 3 minutes, and after this hot press, the pressed product was immediately held and cooled in a cold press at 30° C. for 3 minutes (hereinafter, this cooling method is also referred to as the “cooling method 2” (rapid cooling)). The thickness of the molded article C1 was 0.2 mm.

### Comparative Examples 2 and 3

Molded articles C2 and C3 were produced in the same manner as in Comparative Example 1 except that the distance for sandwiching the polymer in the compression molding machine was changed. The thickness of the molded article C2 was 0.1 mm, and the thickness of the molded article C3 was 0.02 mm.

### Comparative Examples 4 to 6

Molded articles C4 to C6 were each produced in the same manner as in Comparative Example 1 except that the distance for sandwiching the polymer in the compression molding machine was changed. The thickness of the molded article C4 was 0.5 mm, the thickness of the molded article C5 was 1.5 mm, and the thickness of the molded article C6 was 2.8 mm.

### Comparative Example 7

A molded article C7 was produced in the same manner as in Example 1 except that the press pressure was changed to 15 MPa and the distance for sandwiching the polymer in the compression molding machine was changed. The thickness of the molded article C7 was 3.5 mm.

### Comparative Example 8

A molded article C8 was produced in the same manner as in Example 1 except that the polymer 7 was used instead of the polymer 2, the press temperature was changed to 155° C., the press pressure was changed to 15 MPa, and the distance for sandwiching the polymer in the compression molding machine was changed. The thickness of the molded article C8 was 1.1 mm.

### [Evaluation]

### (1) Haze Value and Total Light Transmittance

The haze (Hz) of each of the molded articles 1 to 14 and C1 to C8 was measured using a haze meter “NDH4000” (available from Nippon Denshoku Industries Co., Ltd.) in compliance with JIS K7136. The total light transmittance was also measured using the same haze meter in compliance with JIS K7361-1.

### (2) Tensile Test

A dumbbell-type specimen in compliance with the type IV specified in ASTM D638 was prepared by punching out from each of the molded articles 6 to 14, C4, C5, and C8. The samples prepared were subjected to a tensile test using an Autograph “AG-2000E” (available Shimadzu Corporation) at room temperature of 23° C. and a tensile speed of 50 mm/minute. From the stress-strain curve in this tensile test, the tensile yield stress and the tensile modulus of elasticity were determined.

### (3) Measurement of Crystal Melting Enthalpy (ΔH) and Melting Point of Molded Articles

From each of the molded articles 1, 2, 5, 7 to 14, C4, C5, C7, and C8, a sample for measurement was produced by cutting out a very small piece from each molded article. The samples were subjected to measurement using a differential scanning calorimeter “DSC-1” (available from Mettler-Toledo Inc.) while the temperature was raised from 30° C. to 230° C. at 10° C./minute.

The melting point of the molded article was determined from the temperature of the peak top in the crystal melting peak observed in the temperature raising process. The crystal melting enthalpy was calculated from the area of the crystal melting peak. The degree of crystallinity was determined from the ratio of the crystal melting enthalpy of the molded article to the amount of heat absorbed per unit mass of the PVDF crystal. However, the amount of heat absorbed per unit mass of the PVDF crystal was 104.5 J/g.

The results of the above evaluations are shown in Tables 1 to 4 below.

TABLE 1

| | Polymer | | | | | | Molded article | | |
|---|---|---|---|---|---|---|---|---|---|
| Molded | | Melting | Press conditions | | | | | | Total light |
| article | | point | Temperature | Time | Pressure | Cooling | Thickness | Haze | transmittance |
| No. | No. | [° C.] | [° C.] | [minute] | (MPa) | method | [mm] | % | % |
| 1 | 2 | 175 | 175 | 10 | 10 | 1 | 2.0 | 34 | 73 |
| 2 | 2 | 175 | 175 | 10 | 10 | 1 | 1.7 | 33 | 76 |
| 3 | 2 | 175 | 175 | 10 | 10 | 1 | 1.2 | 32 | 79 |
| 4 | 2 | 175 | 175 | 10 | 10 | 1 | 0.6 | 24 | 87 |
| 5 | 2 | 175 | 175 | 10 | 10 | 1 | 0.2 | 12 | 92 |
| 6 | 2 | 175 | 175 | 10 | 10 | 1 | 1.4 | 25 | 79 |
| 7 | 2 | 175 | 175 | 10 | 10 | 1 | 1.6 | 28 | 78 |
| 8 | 1 | 175 | 175 | 10 | 10 | 1 | 1.5 | 32 | 76 |
| 9 | 3 | 175 | 175 | 10 | 10 | 1 | 1.5 | 24 | 80 |
| 10 | 4 | 175 | 175 | 10 | 10 | 1 | 1.6 | 28 | 79 |
| 11 | 5 | 157 | 162 | 10 | 10 | 1 | 1.5 | 20 | 82 |
| 12 | 6 | 151 | 156 | 10 | 10 | 1 | 0.9 | 33 | 84 |
| 13 | 7 | 168 | 172 | 10 | 10 | 1 | 1.0 | 25 | 85 |
| 14 | 7 | 168 | 165 | 10 | 10 | 1 | 1.4 | 35 | 79 |

TABLE 2

| | Polymer | | | | | | Molded article | | |
|---|---|---|---|---|---|---|---|---|---|
| Molded | | Melting | Press conditions | | | | | | Total light |
| article | | point | Temperature | Time | Pressure | Cooling | Thickness | Haze | transmittance |
| No. | No. | [° C.] | [° C.] | [minute] | (MPa) | method | [mm] | % | % |
| C1 | 2 | 175 | 230 | 3 | 10 | 2 | 0.2 | 63 | 92 |
| C2 | 2 | 175 | 230 | 3 | 10 | 2 | 0.1 | 51 | 93 |
| C3 | 2 | 175 | 230 | 3 | 10 | 2 | 0.02 | 18 | 93 |
| C4 | 2 | 175 | 230 | 3 | 10 | 2 | 0.5 | 83 | 91 |
| C5 | 2 | 175 | 230 | 3 | 10 | 2 | 1.5 | 95 | 81 |
| C6 | 2 | 175 | 230 | 3 | 10 | 2 | 2.8 | 98 | 68 |
| C7 | 2 | 175 | 175 | 10 | 15 | 1 | 3.5 | 65 | 58 |
| C8 | 7 | 168 | 155 | 10 | 15 | 1 | 1.1 | 50 | 84 |

TABLE 3

| | Tensile yield | Tensile modulus of |
|---|---|---|
| Molded | stress | elasticity |
| article No. | (MPa) | (MPa) |
| 6 | 61 | 2000 |
| 7 | 64 | 2400 |
| 8 | 66 | 2200 |
| 9 | 64 | 2300 |
| 10 | 64 | 2300 |
| 11 | 43 | 1300 |
| 12 | 43 | 1000 |
| 13 | 45 | 1400 |
| 14 | 43 | 1500 |
| C4 | 52 | 1800 |
| C5 | 50 | 1600 |
| C8 | 40 | 1100 |

TABLE 4

| | DSC | | |
|---|---|---|---|
| | Melting point of | | Degree of |
| Molded | molded article | ΔH | crystallinity |
| article No. | [° C.] | [J/g] | % |
| 1 | 181.1 | 62 | 59 |
| 2 | 178.4 | 58 | 56 |
| 5 | 177.4 | 57 | 55 |
| 7 | 179.1 | 67 | 64 |
| 8 | 182.9 | 74 | 71 |
| 9 | 181.5 | 57 | 55 |
| 10 | 177.4 | 55 | 52 |
| 11 | 157.6 | 43 | 41 |
| 12 | 147.0 | 45 | 43 |
| 13 | 178.1 | 45 | 43 |
| 14 | 174.6 | 50 | 48 |
| C4 | 175.8 | 50 | 47 |
| C5 | 175.8 | 49 | 46 |
| C7 | 181.3 | 59 | 56 |
| C8 | 148.7 | 30 | 28 |

As is clear from Table 1, all the molded articles 1 to 14 have a thickness greater than 50 μm and a haze of 40% or less. In contrast, as is clear from Table 2, all the molded articles C1 to C8 have a haze of greater than 40% or has a thickness of 50 μm or less.

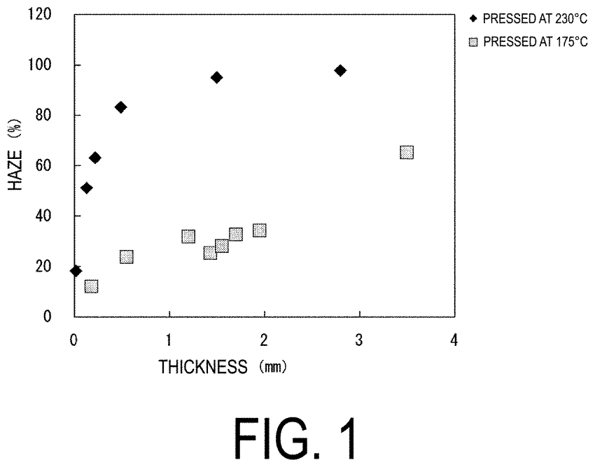

Here, FIG. 1 is a diagram illustrating the correlation between the thickness and the haze of the molded articles. In FIG. 1, the plot of eight squares represents molded articles for which the press temperature was 175° C. The squares each represent, from the origin side, the molded articles 5, 4, 3, 6, 7, 2, 1, and C7. Also in FIG. 1, the plot of six diamonds represents a molded article for which the press temperature was 230° C. The diamonds each represent, from the origin side, the molded articles C3, C2, C1, C4, C5, and C6.

As shown by the square plot in FIG. 1, in the case where gradual cooling was conducted after molding at a press temperature of 175° C., the thickness and the haze of the molded articles show a linear positive correlation. From this correlation, it can be seen that the thickness of the molded article is preferably 2000 μm or less from the perspective of achieving a haze of 40% or less, preferably 1500 μm or less from the perspective of achieving a haze of 30% or less, and preferably 500 μm or less from the perspective of achieving a haze of 20% or less.

Meanwhile, as shown by the diamond plot in FIG. 1, in the case where rapid cooling was conducted after molding at a press temperature of 230° C., the thickness and the haze of the molded articles show an exponential correlation. From this correlation, it can be seen that the molded articles produced by rapid cooling after molding at a press temperature of 230° C. has a low haze when the thickness is extremely small but the haze increases abruptly in association with slight increase in the thickness.

Further, even in the case where the polymer is a vinylidene fluoride copolymer, a positive correlation between the thickness and the haze of the molded article is suggested, for example, from the molded articles 13 and 14. As is clear from the comparison between the molded articles 1 to 7 and the molded articles 13 and 14, the correlation coefficient in this positive correlation tends to be higher in the vinylidene fluoride copolymers than in the vinylidene fluoride homopolymer.

Furthermore, as is clear from the comparison among the molded articles 7 to 10, for example, when the thicknesses of the molded articles are equivalent, it can be seen that the hazes of the molded articles are also substantially equivalent regardless of the difference in the inherent viscosities of the polymers of the molded articles, that is, the difference in the types (molecular weights) of the polymers.

In addition, as is clear from the comparison between the molded articles 1 to 7 and the molded articles C1 to C6, the total light transmittance of the molded articles has a linear negative correlation with respect to the thickness of the molded articles regardless of the press conditions in the molding step and the haze.

Further, for example, as is clear from the comparison between the molded articles 6 and 7 and the molded articles C4 and C5, the tensile yield stress in the tensile test of the molded articles is approximately 60 MPa or greater in the molded articles obtained at a press temperature of 175° C. by slow cooling. In contrast, the tensile yield stress is about 50 MPa in the molded articles obtained at a press temperature of 230° C. by rapid cooling. As described above, it can be seen that the tensile yield stress of the molded articles obtained at the press temperature of 175° C. by slow cooling is higher than that of the molded articles obtained at a press temperature of 230° C. by rapid cooling (Table 3).

Further, for example, as is clear from the comparison between the molded articles 1, 2, 5, and 7 and the molded articles C4 and C5, the melting point of the molded articles obtained at a press temperature of 175° C. by slow cooling is higher than the melting point of the polymer 2 as a raw material (175° C.) (Table 4). Therefore, it can be seen that the crystal structure of the molded articles obtained at press temperature of 175° C. by gradual cooling is densified.

### Examples 15 to 17 and Comparative Example 9

Molded articles 15, 17, and C9 were each prepared in the same manner as in Example 8 except that the press temperature was changed from 175° C. to 170° C., 180° C., and 185° C., respectively and the distance for sandwiching the polymer in the compression molding machine was changed. The thickness of the molded article 15 was 1.2 mm, the thickness of the molded article 17 was 0.3 mm, and the thickness of the molded article C9 was 0.8 mm.

In addition, a molded article 16 was prepared in the same manner as in Example 8 except that the distance for sandwiching the polymer in the compression molding machine was changed. The thickness of the molded article 16 was 0.7 mm.

### [Evaluation]

The Haze and total light transmittance were determined for each of the molded articles 15 to 17 and C9 in the same manner as for the molded article 1 and the like. The results are shown in Table 5.

TABLE 5

| Molded | Polymer | | Press | | | Total light |
|---|---|---|---|---|---|---|
| article | | Melting point | temperature | Thickness | Haze | transmittance |
| No. | No. | [° C.] | [° C.] | [mm] | % | % |
| 15 | 1 | 175 | 170 | 1.2 | 36 | 79 |
| 16 | 1 | 175 | 175 | 0.7 | 15 | 86 |
| 17 | 1 | 175 | 180 | 0.3 | 35 | 91 |
| C9 | 1 | 175 | 185 | 0.8 | 84 | 94 |

As is clear from Table 5, if the press temperature is within the range of the melting point of the polymer 1±5° C., the molded articles exhibits a low haze regardless of the thickness of the molded articles. In contrast, in the case where the press temperature is higher than the melting point of the polymer 1 by 10° C. or more, the haze of the molded article increases, and the transparency of the molded article is impaired.

### Examples 18 to 20

A molded article 18 was prepared in the same manner as in Example 1 except that the distance for sandwiching the polymer in the compression molding machine was changed. The thickness of the molded article 18 was 0.8 mm.

A molded article 19 was prepared by performing an annealing treatment on the molded article 18. Heating in this annealing treatment was carried out under the conditions of leaving the molded article in an oven at 100° C. for 1 hour. Furthermore, a molded article 20 was produced by performing a different annealing treatment on the molded article 18. Heating in this annealing treatment was carried out under the conditions of leaving the molded article in an oven at 150° C. for 1 hour. The thickness of the molded article 19 was 0.7 mm, and the thickness of the molded article 20 was 0.8 mm.

### Evaluation

The Haze and total light transmittance were determined for each of the molded articles 18 to 20 in the same manner as for the molded article 1 and the like. The results are shown in Table 6. In Table 6, “Haze difference” indicates the difference of the haze of the molded articles 19 and 20 from the haze of the molded article 18.

TABLE 6

| Molded | Annealing treatment | | | | Haze | Total light |
|---|---|---|---|---|---|---|
| article | Temperature | Time | Thickness | Haze | difference | transmittance |
| No. | [° C.] | [Hour] | [mm] | % | % | % |
| 18 | — | — | 0.8 | 15 | — | 87 |
| 19 | 100 | 1 | 0.7 | 15 | 0 | 87 |
| 20 | 150 | 1 | 0.8 | 18 | 3 | 85 |

As is clear from Table 6, in the molded articles for which the press temperature is within the range of the melting point of the polymer ±5° C. and which were then gradually cooled and molded, both the haze and the total light transmittance thereof are not substantially changed by the annealing treatment. Therefore, it is can be seen that such molded articles have both the effect of the annealing treatment (the effect of relaxing the stress and the effect of densifying the crystal structure) and its excellent optical properties.

### INDUSTRIAL APPLICABILITY

The present invention can be utilized in highly transparent members.

1. A molded article comprising a vinylidene fluoride homopolymer, wherein
the molded article has a thickness greater than 50 μm, and has a haze value of 40% or less when the thickness of the molded article is 2 mm.

2. The molded article according to claim 1, wherein a crystal melting enthalpy measured by a differential scanning calorimeter is 40 J/g or greater and 80 J/g or less.

3. The molded article according to claim 1, having a tensile yield stress of 40 MPa or greater.

4. The molded article according to claim 1, wherein a haze after an annealing treatment is 40% or less.

5. (canceled)

6. The molded article according to claim 1, wherein the molded article is in a sheet-like shape.

7. A method for producing the molded article described in claim 1, the method comprising:
a molding step of melting and molding the polymer composition having a shape to be molded; wherein
in the molding step, the polymer composition is melt by heating the polymer composition to a temperature in a range of a melting point of the polymer ±5° C.

8. The method for producing the molded article according to claim 7, wherein, in the molding step, the polymer composition is pressed by a press member and formed into a sheet-like shape while the polymer composition is melted by heating the press member.

9. The method for producing the molded article according to claim 7, wherein the melting point of the polymer is from 170 to 180° C.
